(19) United States
(12) Patent Application Publication
(10) Pub. No.: US 2007/0209987 A1
(43) Pub. Date: Sep. 13, 2007

(54) Water purification devices

(76) Inventor: Stephan B. Sears, Menlo Park, CA (US)

Correspondence Address: MANDEL & ADRIANO, 55 SOUTH LAKE AVENUE, SUITE 710, PASADENA, CA, 91101, US

(21) Appl. No.: 11/706,495

(22) Filed: Feb. 15, 2007

Related U.S. Application Data
(60) Provisional application No. 60/773,388, filed on Feb. 15, 2006.

(51) Int. Cl. C02F 1/02

(52) U.S. Cl. 210/180; 210/188

(57) ABSTRACT

The invention is a water purification device, and method, for removing contaminants from water for consumption, consisting of: 1) one or more heat exchangers for transferring heat between steam and water, and/or between water and water, and/or between steam and liquid, and/or between steam and air, and/or between air and liquid, where at least one heat exchanger is located before a degasser; 2) a heater; 3) a boiler chamber; 4) a demister; 5) a degasser located before the boiler chamber; and, 6) a self-cleaning component. Additional embodiments include an air-cooled device.

This application claims priority to provisional patent application, U.S. Ser. No. 60/773,388, filed Feb. 15, 2006, the contents of which are hereby incorporated by reference in their entirety herein.

Throughout this application various publications are referenced. The disclosures of these publications in their entireties are hereby incorporated by reference into this application in order to more fully describe the state of the art to which this invention pertains.

### FIELD OF THE INVENTION

The present invention relates to water purification devices for removing impurities from fluids, such as water, and more particularly to water purification devices including one or more heat exchangers, and air-cooled water processing devices.

### BACKGROUND OF THE INVENTION

The earth is largely water with only a tiny fraction available for drinking or irrigation. The majority of the water is contained in our oceans and is too salty for human consumption. Most of the water currently used for drinking and irrigation is fresh water at less than half of 1% of the global water supply. A considerable number of people on earth lack clean drinking water, with contaminated drinking water involved in a large percentage of all human illness and disease including gastroenteritis, dysentery, cholera and other waterborne diseases which claim many human lives each year. Abundant, clean water can improve the lives of people worldwide.

In addition to the need for purified water for consumption, purified water is also needed for scientific, medical (e.g. hospital and laboratory) uses, for agriculture.

The water supply systems in the United States are under increasing strain with reoccurring drought and contamination. Water is being removed from underground reservoirs known as aquifers, too fast to allow for rainwater to refill these resources. Moreover, purification efforts of ocean water are presently insufficient to provide an adequate supply of fresh water.

Problems of water scarcity are intensified by pollution of our fresh water supplies. In the United States, trihalomethane gases, known to cause cancer in laboratory animals, contaminate virtually all of our drinking water as a result of the chlorination process that city water systems use to prevent the spread of waterborne diseases. Trihalomethanes form when chlorine interacts with algae, microorganisms or other organic materials in the water. Other contaminants originate in the delivery system—lead from water pipes leach into our tapwater. Pollutants are also contaminating groundwater. Salt thrown on icy roadways has worked its ways into aquifers in New England, and wells are vulnerable to contamination from dumped toxic chemicals, including pesticides. Once groundwater is contaminated, it stays contaminated for many, many years.

The Environmental Protection Agency (EPA) is restricting the dumping of waste water by cities.

Currently, a variety of purification systems use filters, for example paper or metal mesh filters, to purify tap water. (Pur Water Filtration System, www.purwater.com). However, people have relied on distillation as a separation technique to purify water for thousands of years. Essentially all fresh water on earth comes from distillation. Distillation is a process of evaporation and condensation which involves vaporizing a feed liquid to be purified, and condensing the vapors to obtain pure water product. The portion of the feed liquid that does not vaporize, becomes concentrated. This concentrated liquid also known as “blowdown,” carries impurities out. The problem with distillation is the extremely high amount of energy it takes to vaporize water. About 1200 BTU per gallon (0.35 kwh), are required to heat the feed water from 60° F. (16° C.) to 212° F. (100° C.), its boiling point. After water reaches its boiling point, about 8000 BTU (2.34 kwh) of heat energy, are required to convert a gallon of the water to steam. The goal of improving distillation methods is to develop devices that reduce energy consumption, e.g. recycle energy, and produce adequate amounts of purified water.

In the past, people have purified water for consumption using a home distillation apparatus known as a still. Conventional tapwater stills consist of a boiling chamber, a condensing chamber, and an electric heater. The heater boils the impure water. Steam travels to the condensing chamber and condenses, becoming distilled water. These stills remove solid pollutants that contaminate the drinking water. But such stills won't remove toxic gases or liquids, which bubble off with the escaping steam, contaminating the product water.

Recently, there have been water purification devices developed that employ a distillation process including a heat exchanger that both heats incoming feed water to be purified and cools exiting product steam to produce product water, a boiler, a degasser, a demister, and a self-cleaning mechanism, for consumer use. (U.S. Pat. Nos. Nos. 6,858,150 and 6,663,770, by Stephan B. Sears). This device produces purified water using reasonable amounts of energy. Other devices, such as those described by SylvanSource (www.SylvanSource.com), describe the use of one heat exchanger to heat incoming feed water, and a heat exchanger (condenser) to air cool outgoing product steam to produce product water.

There remains a need for improved water purification devices, that are economical to manufacture and use, for processing water to remove impurities.

### SUMMARY OF THE INVENTION

Accordingly, the present invention provides a point of use water purification device, that produces multiple gallons of pure water from impure water, over twenty four (24) hours, using reasonable amounts of electrical power. The device removes contaminating solids, liquids and dissolved gases, from the incoming impure water, using a distillation process. In one embodiment, the water purification device contains:
a) one or more heat exchangers, for heat transfer between water and steam, and/or between water and water, and/or between water and air, and/or between steam and air, in a water purification device; at least one heat exchanger positioned in the device such that water to be purified in the device, passes through said heat exchanger, before entering a degasser;
b) a boiler having a chamber for boiling water to be purified to produce steam;
c) a heat source for heating water in the boiler;
d) a degasser for removing noncondensible gases and volatile liquids from water to be purified, the degasser positioned in the device such that water to be purified is degassed before entering the boiler; and
e) a demister, for removing liquid droplets from steam and producing dry, purified product steam.

Preferably the device includes a self cleaning mechanism for removing deposits on the boiler chamber surfaces.

In an embodiment, the water purification device has at least one heat exchanger that transfers heat between steam and water.

The invention further includes a method for removing contaminants from water using distillation to produce substantially purified water comprising:
a) passing water through one or more heat exchangers, for heat transfer between water and steam, and/or between water and water, and/or between air and water, and/or between air and steam, wherein the water is passed through at least one heat exchanger prior to degassing the water;
b) degassing the incoming water to be purified to remove noncondensible gases and volatile liquids;
c) boiling the water degassed in step b) to produce steam; and
d) removing water from the steam produced in step c) to produce dry, purified product steam.

The method can further comprise the step of condensing the dry steam produced in step d), to produce substantially purified liquid water.

### BRIEF DESCRIPTION OF THE DRAWINGS

FIG. 1A, B and C is a perspective view of a fully assembled transparent embodiment of the water purification device of the invention, looking through the outer walls of the device (A with top and cover, B and C, without top and cover), as described infra.

FIG. 2 is an exploded view of the water processing device of the invention, showing the components, and relative positioning of the components, as described in detail, infra.

FIG. 3 is a flow chart incorporating the key components of the water processing device of the invention, showing the flow of water and steam throughout the device of the invention, as described, infra.

FIG. 4 A and B is an exploded view of the degasser (4A), and self cleaning wiper and gear motor (4B) of the device of the invention, as described, infra.

FIG. 5 is a further illustration of an embodiment of the self-cleaning mechanism and water seal of the device of the invention, as described, infra.

FIG. 6A and B is a perspective view of a fully assembled transparent embodiment of the air-cooled water purification device of the invention, looking through the outer walls of the device, as described infra (6A is a view with the outer cover and top in place on the device; 6B is a view without the cover and top in place).

FIG. 7 is an exploded view of an air-cooled embodiment of the water purification device of the invention, showing the components described, infra.

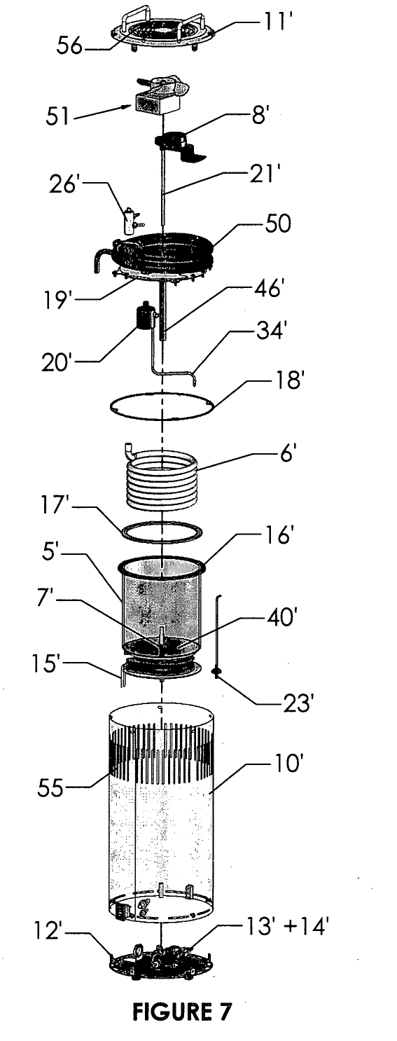

### DETAILED DESCRIPTION OF THE INVENTION

The present invention provides an improved water purification device that can be operated continuously with reasonable energy usage, and provides removal of contaminating solids, liquids and gases from water, for human consumption, using a distillation process.

The water purification device of the invention incorporates several key structural components that provide optimal purification, for a given inflow of water and energy consumption. These key structural components are: 1) one or more heat exchangers, for heat transfer between water and steam, and/or between water and water, and/or between air and water, and/or between air and steam, in a water purification device; at least one heat exchanger positioned in the device such that water to be purified in the device, passes through the heat exchanger, before passing through a degasser; 2) a heater; 3) a boiler chamber; 4) a degasser; 5) a demister; and 6) a self-cleaning component. The device provides several advantages over prior distillation apparati, removing substantially more contaminants from the impure, incoming (“feed”) water using reasonable amounts of energy consumption.

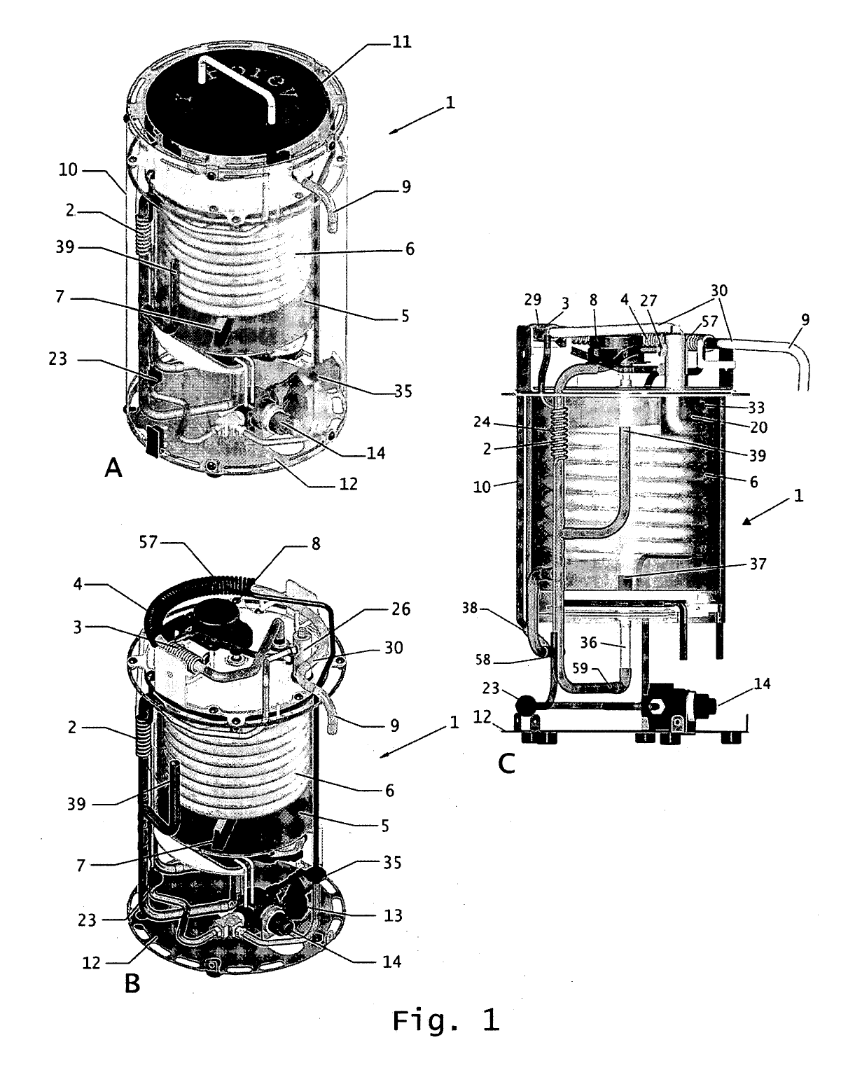

Referring to FIG. 1A, B and C, illustrate an embodiment of an assembled water purification device 1 of the invention, including the major components of the device 1; three heat exchangers 2, 3 and 4 (FIGS. 1B and 1C), the boiler chamber 5 (FIGS. 1A, 1B and 1C), the degasser 6 (FIGS. 1A, 1B and 1C), the demister 20 (FIG. 1C), and optionally, a self cleaning mechanism 7 (FIGS. 1A and 1B) and gear motor 8 (FIGS. 1B and 1C). FIG. 1 also illustrates the pure water product exit tube 9 (FIGS. 1A, 1B and 1C), and a cover 10 (FIG. 1A), and top 11 (FIG. 1A), that may be placed over the device 1. Heat exchanger 2 heats incoming water by transferring heat from outgoing steam to incoming water, and to the extent the outgoing steam condenses in the exchanger to water, between the condensed steam (i.e. hot water) and water. Heat exchanger 3 further heats incoming water and cools outgoing product water, by transferring heat from outgoing dry steam to incoming feed water, and to the extent the dry steam condenses in the exchanger to water, between the condensed steam (i.e. hot water) and incoming water. Heat exchanger 4 further cools the exiting product water and steam, by transferring heat between the condensing steam and hot product water and incoming (cooling) water, and to the extent the steam condenses in the exchanger into water, between the condensed steam (water) and cooling water.

Continuing to view FIG. 1B, moving upward from the base of the water purification device 1 to the top, the device 1 includes a bottom 12. Above the bottom 12 is a Y strainer 13 containing a mesh screen, to remove particulate matter present in the incoming feed water, such as sand, plant material, insects, and other detritus. The Y strainer 13 is connected to a regulator 14 that regulates the pressure of incoming feed water through the device 1. For example, the pressure is regulated to around 15 psi.

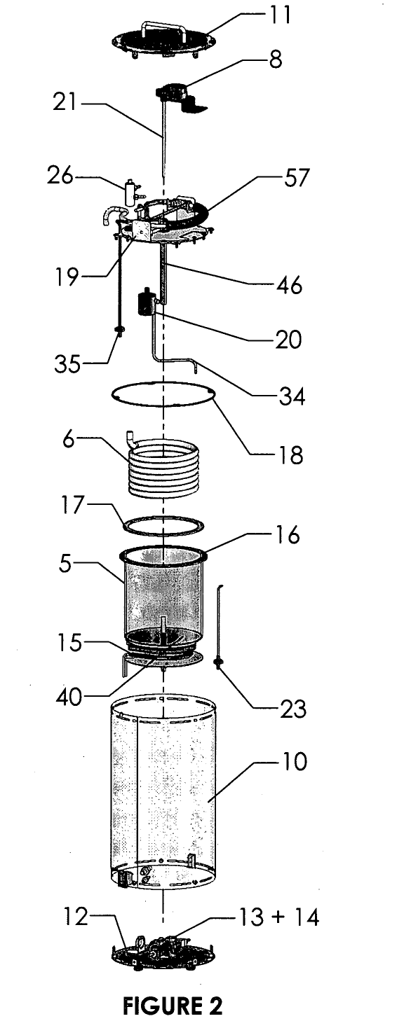

Referring to FIG. 2, above the bottom 12 of the device is a heater 15 and the boiler chamber 5 for boiling degassed feed water that exits from the degasser 6. A flange 16 on the top of the boiler chamber 5 receives gasket 17. A lid mount 18 is included for mounting the boiler chamber lid 19, when assembled. The demister 20 with outlet 34, for removing water droplets from the steam exiting the boiler chamber 5, is located below the boiler chamber lid 19. Above the boiler chamber lid 19, is located the gear motor assembly 8.

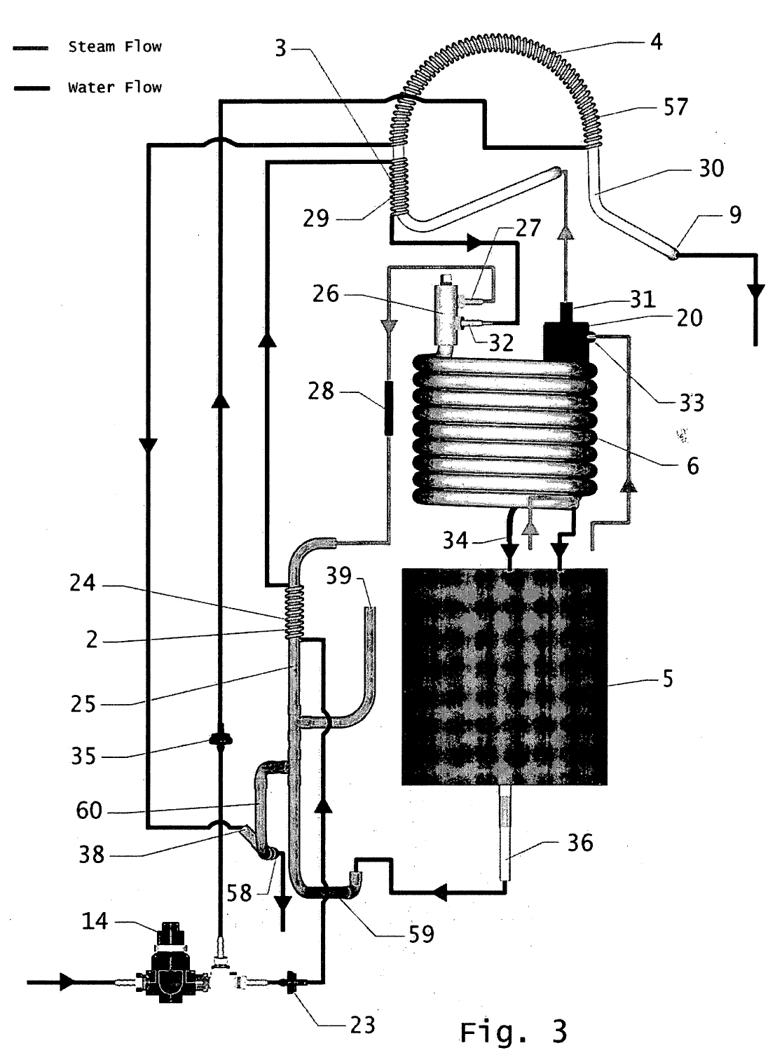

FIG. 3 depicts the flow of water throughout an embodiment of the water purification device 1, of the invention. After passing through the Y strainer 13 and regulator 14, the incoming feed water is divided into two paths: 1) cooling water that flows to heat exchanger 4 for transferring heat between dry steam from the demister 20 (that has exited demister port 31); and 2) feed water to be purified in the device 1 that flows to heat exchanger 2 for heat exchange between the feed water and steam exiting the degasser 6 through adapter assembly 26 from the boiler chamber 5.

The incoming feed water passes through a flow restrictor 23, for example a 0.5 gal/hr restrictor, and then enters a coil 24 of a first heat exchanger 2 that surrounds a conduit 25. This first heat exchanger 2 heats the incoming feed water by transfer between the hot, exiting steam from port 27 of the adapter assembly 26 from the degasser 6. A steam flow restrictor 28 regulates the flow of steam out of the boiler chamber 5 through the degasser 6, e.g. approximately ten percent (10%) of the steam produced in the boiler chamber 5, flows into the degasser 6. The heat exchanger 2 cools the steam exiting from the degasser 6 by condensation, producing waste water, carrying gaseous impurities, that exits the water purification device 1 via end 58 of conduit 60.

Continuing with reference to FIG. 3, after exiting the heat exchanger coil 24 of heat exchanger 2, the feed water enters the coil 29 of another heat exchanger 3, surrounding a conduit 30 that carries dry, purified steam, that has exited the demister 20 through port 31, and the feed water is heated to boiling temperature, as a result. The feed water exiting the coil 29 of heat exchanger 3 then enters the degasser 6 conduits through a port 32 in an adapter assembly 26, and counterflows in the degasser 6 below steam exiting the boiler chamber 5. The majority of steam, e.g. approximately ninety percent (90%) from the boiler chamber 5, enters the demister 20 through demister inlet 33.

In the degasser 6, impurities such as dissolved gases and volatile liquids, are removed (“stripped”) from the feed water, and the degassed feed water then flows into the boiler chamber 5, where it is heated to produce steam. The degasser 6 can consist of 0.5 inch diameter pipe or tubing, approximately twelve feet in length. The demister 20 removes entrained liquid droplets from the steam, resulting in “dry steam.” The dry steam then proceeds from port 31 of the demister 20 to the conduit 30 of heat exchangers 3 and 4, where it is cooled (condensed) to liquid form, by exchange with the water circulating in the coil 29 of heat exchanger 3, from heat exchanger 2, and exchange with the cooling water circulating in the coil 57 of heat exchanger 4. The cooled, purified water exits via exit tube 9, as product water for consumption. From the demister 20 the liquid droplets removed from the steam in the demister 20 are returned into the boiler chamber 5 through a demister drain tube 34. In an alternative embodiment, the water droplets exiting the demister can be carried out of the device as waste water.

The incoming cooling water that is diverted after exiting the Y strainer 13 and regulator 14, enters a flow restrictor 35, e.g. a 2 gallon/hr restrictor, and then flows through the coil 57 of heat exchanger 4, further cooling the steam that has exited the demister 20 and passed through heat exchanger 3. This cooling water exits the coil 57 as waste water, after entering the end 38 of conduit 60 and exiting at end 58. Blowdown exiting the boiler chamber 5 through conduit 59, and steam exiting the adapter assembly 26 of the degasser 6 through conduit 25 combine to exit the device from end 58 of conduit 60.

As shown in FIG. 1C, to control the level of water in the boiler chamber 5, a conduit 36 is provided, one end 37 of which extends, for example, up approximately 0.5 inch from the inner, bottom surface of the boiler chamber 5, and continues downward, into a “U” shape, similar to a “P trap” under a kitchen sink. If the water level rises too high in the boiler chamber 5 the excess flows into the end 37 of conduit 36, e.g. greater than 0.5 inch from the bottom, the excess overflows into the conduit 36, and through conduit 59, to combine with the outgoing cooling water entering conduit 60 at end 38, and condensed steam and gasses exiting from the degasser 6, as waste water from the degasser 6. The other end 39 of the overflow conduit 36 is open to the air inside the device 1, and prevents water from being siphoned off from the boiler chamber 5.

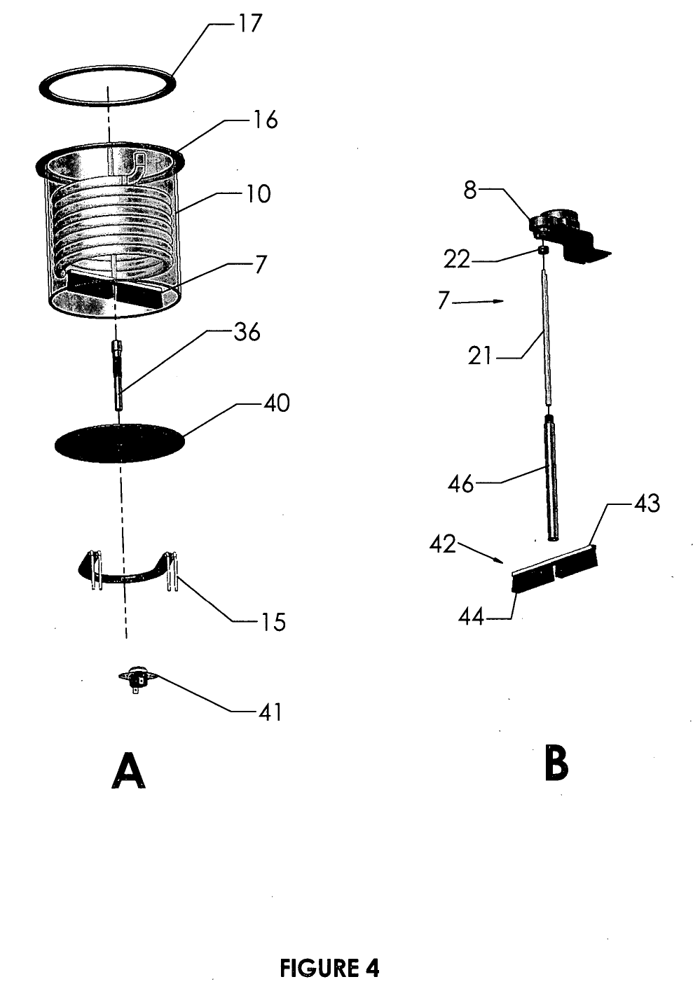

As shown in FIG. 4A, a heater 15 is provided below the bottom plate 40 of boiler chamber 5. In addition, an overload thermostat 41 is provided that turns the heater off if it reaches excessive temperatures, for example above 300° F. Suitable thermostats are widely available, for example a 0.75 Disc Thermostat with automatic reset (Sefco/ECC, Anaheim, Calif.).

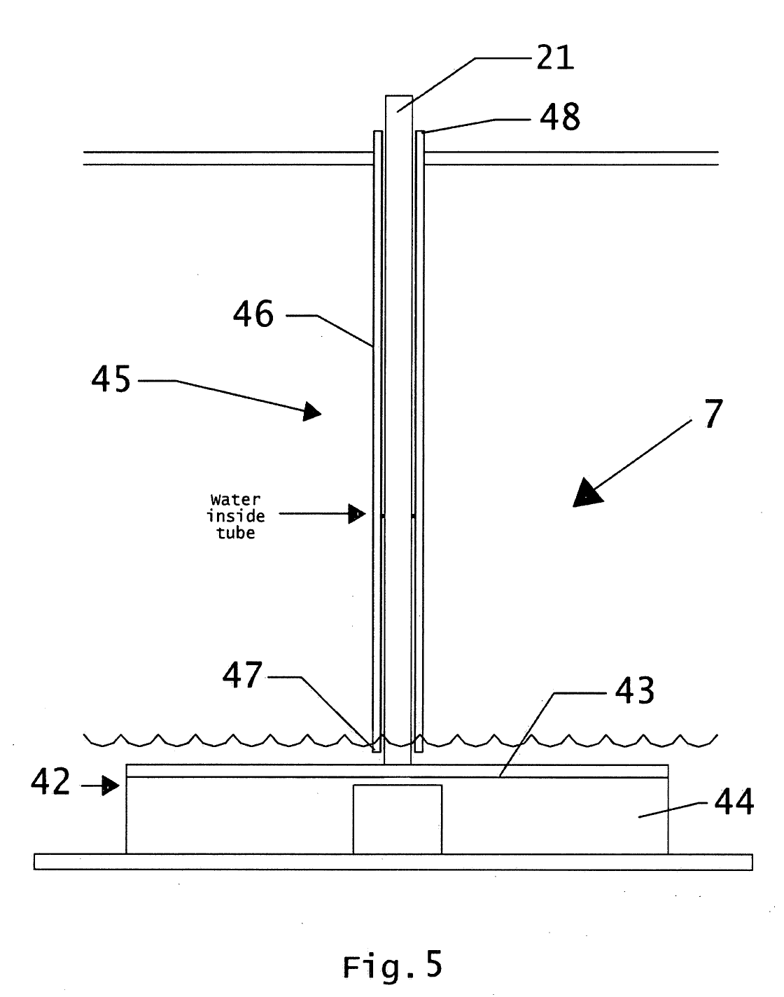

The self-cleaning mechanism of the device 1 of the invention may consist of a wiper 7 as shown in FIG. 4B and FIG. 5, that sweeps the bottom of the boiler chamber 5, to remove any buildup of deposits. Referring to FIG. 4B, the wiper 7, has a central shaft 21 and a wiper blade 42 having a horizontal component 43 with downwardly extending blades or brushes 44. The central wiper shaft 21 is operated, for example, by gear motor 8, having gear alignment collar 22, that aligns wiper shaft 21 at from 5-15 rpm. Suitable motors are available, for example a 9 rpm, polyvolt motor (Custom Products Corporation, North Haven, Conn.).

In another embodiment of the invention, self-cleaning is provided by marbles, for example, glass or metal marbles, which are moved around the bottom surface of the boiler chamber, as a result of the boiling of water in the boiler chamber. The movements of the marbles dislodge and prevent buildup of deposits in the boiler chamber.

Shown in FIG. 5, is the water seal 45 of the invention, which consists of a hollow outer conduit 46 surrounding the wiper central shaft 21. The water seal 45 prevents steam from leaking out of the device around the central wiper shaft 21. The outer conduit 46 of the water seal 45 is of greater diameter than the diameter of the central wiper shaft 21. The bottom 47 of the water seal conduit 46 lies at, or below the surface of the water in the boiler chamber 5. Water in the boiler chamber 5 moves into the bottom 47 of the outer water seal conduit 46 and upwards, until a point of equilibrium where the weight of the water inside the outer water seal conduit 46 of the water seal 45 is equal to the pressure above the water in the boiler chamber 5. The top 48 of outer water seal conduit 46 extends to a sufficient height to prevent water inside the outer water seal conduit 46 from rising above the top 48 of the outer water seal conduit 46. This prevents steam in the boiler chamber 5 from leaking up and out of the device around the central wiper shaft 21, and provides a long-lasting seal.

The water processing device 1 can be connected to a household source of incoming water to be purified, for example a sink faucet, or the incoming water hose for a clothes washing machine, and a simple diverter valve can be used to direct the water.

The devices of the invention remove most contaminants present in water, including chlorine, dissolved gases, toxins including lead and asbestos, volatile liquids, salts, minerals, radioactive elements, bacteria and viruses, without filters.

The water cooled configuration of the embodiment of the device depicted in FIGS. 1-5, produces at least 6 gallons of purified water over 24 hours, using, a regulator that regulates the pressure of incoming water through the device to around 15 psi, and ½ gal/hr and 2 gal/hr flow restrictors provides 2.5 gallons of water per hour, flowing through the device. Approximately 800 watts of electrical energy is used to heat water in the boiler chamber.

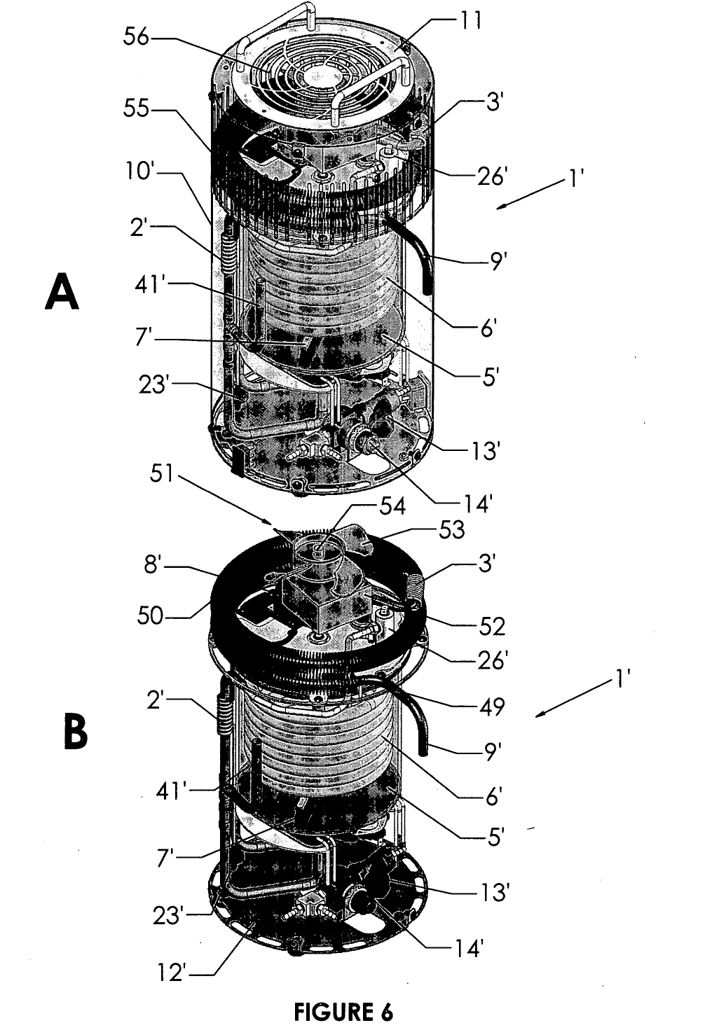

In an air-cooled embodiment of the invention 1′ as shown in FIGS. 6A and B, and 7, the components are the same as shown in FIGS. 1-5 herein (2-48), except that the dry steam exiting the demister 20′ enters the conduit 49 of condensing coil 50 (FIG. 6A) which has “fins” encircling the conduit 49, and is air-cooled by, e.g. a fan 51 with a fan motor 52 and fan blades 53 (FIG. 6A). This condensing coil 50 replaces the heat exchanger 4, shown in FIG. 1. The fan blades 53 of fan 51 rotate around the central shaft 54 of the fan 51 above the condensing coil 50. The dry hot steam exiting the demister 20′ is cooled by transferring heat to the outside air. In turn, the steam condenses to liquid form, and exits conduit 49 of the device 1′ as liquid, purified water through outlet 9′. The cover 10′ of the air-cooled embodiment of the device, preferably includes openings 55 for air to circulate, as does the top 11′ having openings 56. Other components correspond to the components in the embodiment depicted in FIG. 1: 2′-48′(absent heat exchanger 4).

Embodiments of the invention that do not depart from the spirit and scope of the invention, include devices that produce different quantities of purified water per hour, different pressure flows, different amounts of electrical energy used to heat water to be purified in a chamber, different or no self-cleaning mechanisms, e.g. marbles in place of wiper blades, and alternative configurations of the key components of the invention: boiler, degasser, demister, and heat exchangers.

### Uses of the Compact Water Processing Device of the Invention

The water processing device of the invention has a number of uses. The device is used to remove contaminants from tapwater, and can be used to purify seawater or wastewater, for example during droughts, or in areas where fresh water is scarce. The costs of operating the device continuously, are well within the budget of many American consumers and businesses, and can be made available through various forms of assistance to a broader group of users, worldwide.

While several illustrative embodiments of the invention have been shown and described, numerous variations and alternate embodiments will occur to those skilled in the art. Such variations and alternate embodiments are contemplated, and can be made without departing from the spirit and scope of the invention, as defined in the appended claims and equivalents thereof. The embodiments are not intended in any way to otherwise limit the scope of the disclosure of the protection granted by Letter Patent granted hereon.

What is claimed:

1. A water purification device for removing contaminants from water comprising:
a) one or more heat exchangers, for heat transfer between water and steam and/or between water and water, and/or between air and water and/or between air and steam, in a water purification device; at least one heat exchanger positioned in the device such that water to be purified in the device, passes through said heat exchanger, before entering a degasser;
b) a boiler having a chamber for boiling water to be purified to produce steam;
c) a heat source for heating water in the boiler;
d) a degasser for removing noncondensible gases and volatile liquids from water to be purified, the degasser positioned in the device such that water to be purified is degassed before entering the boiler; and
e) a demister, for removing liquid droplets from steam and producing dry, purified product steam.

2. The water purification device of claim 1, comprising at least one heat exchanger that transfers heat between steam and water.

3. The water purification device of claim 1, further comprising a self-cleaning mechanism for preventing and/or removing surface deposits on the boiler chamber.

4. The water purification device of claim 3, wherein said mechanism is a wiper blade comprising a central shaft and horizontal wiping blade or brush located in the boiler chamber, said central shaft extending out the top of the boiler chamber.

5. The water purification device of claim 3, wherein said self-cleaning mechanism comprises marbles placed in the bottom of the boiler chamber.

6. The water purification device of claim 1, further comprising a means for air cooling steam or water, in the device.

7. An air-cooled water purification device for removing contaminants from water comprising:
a) one or more heat exchangers for transfer between water and steam, and/or between water and water, and/or between air and water, and/or between air and steam, at least one heat exchanger positioned in the device such that water to be purified in the device, passes through said heat exchanger, before a degasser;
b) a boiler having a chamber for boiling water to be purified to produce steam;
c) a heat source for heating water in the boiler;
d) a degasser for removing noncondensible gases and volatile liquids from the feed water, positioned in the device such that degassed feed water enters the boiler; and
e) a demister, for removing liquid droplets from steam, and producing dry, purified product steam.

8. The air-cooled water processing device of claim 7, further comprising a self-cleaning mechanism for preventing and/or removing surface deposits in the boiler chamber.

9. A method for removing contaminants from water using distillation to produce substantially purified water comprising:
a) passing incoming water to be purified through one or more heat exchangers, for heat transfer between water and steam, and/or between water and water, and/or between air and water, and/or air and steam;
b) degassing the incoming water to be purified to remove noncondensible gases and volatile liquids;
c) boiling the water degassed in step b) to produce steam; and
d) removing water from the steam produced in step c) to produce dry, purified product steam.

10. The method of claim 9 further comprising the step of condensing the dry steam produced in step d) to produce substantially purified liquid water.
